(19) United States
(12) Patent Application Publication
(10) Pub. No.: US 2015/0263417 A1
(43) Pub. Date: Sep. 17, 2015

(54) SATELLITE ANTENNA HOUSING

(71) Applicant: Intellian Technologies INC., Pyeongtaek-si (KR)

(72) Inventors: Hyun Soo Kim, Ansan-si (KR); Min Son Son, Hwaseong-si (KR); Jeong Woo Park, Yongin-si (KR); Geun Ho Choi, Osan-si (KR)

(21) Appl. No.: 14/417,903

(22) PCT Filed: Jul. 31, 2013
(86) PCT No.: PCT/KR2013/006858

§ 371 Date: Jan. 28, 2015

(30) Foreign Application Priority Data
Aug. 7, 2012 (KR) 10-2012-0086162
Aug. 7, 2012 (KR) 10-2012-0086163

(51) Int. Cl. H01Q 1/42

(52) U.S. Cl. CPC H01Q 1/422

(57) ABSTRACT

A satellite antenna housing includes: a first layer; a second layer formed so as to be in contact with one side of the first layer; a third layer formed so as to be in contact with one side of the second layer and face the first layer; a fourth layer so as to be in contact with one side of the third layer and face the second layer; and a fifth layer so as to be in contact with one side of the fourth layer and face the third layer, wherein the first layer, the third layer, and the fifth layer may be formed of a material having a dielectric constant higher than that of the second layer and the fourth layer, and the second layer and the fourth layer may have a thickness greater than that of the first layer, the third layer, and the fifth layer.

### TECHNICAL FIELD

The present invention relates to a satellite antenna housing, and more particularly, provides a satellite antenna housing that enables transmission of a broadband radio wave in a band of a satellite with a small transmission loss, maintains a high strength, and also, achieves a constant performance regardless of a position or a location of the housing.

### BACKGROUND ART

Generally, a satellite antenna housing is used to protect a satellite antenna from the external environment including weather phenomena such as rain, snow, and wind, and physical impacts, and the like. A desirable housing is required to protect an antenna and also to enable transmission of a satellite signal, i.e. an electromagnetic wave, incident to the antenna without a transmission loss. However, a conventionally used housing has a problem that it generates a transmission loss of electromagnetic waves due to plastic used to maintain a high strength, and if an incident electromagnetic wave is tilted at a certain angle or more with respect to the housing, a beam pattern of an antenna is changed.

A housing for a mobile satellite broadcasting transmitting/receiving or communicating antenna is installed at a satellite antenna mounted on a mobile object such as a vehicle, and a ship, and, thus, it has an inclination with respect to the satellite. The tilt angle with respect to the satellite varies depending on a region or a country where the mobile object is located and may be in the range of from about −20 degrees to about +120 degrees depending on an elevation angle of the satellite antenna.

Further, a housing for a mobile satellite broadcasting communicating antenna can electronically trace a satellite in an elevation direction so as to continuously head for the satellite regardless of a movement of a mobile object.

Conventional satellite antenna housings can be largely classified into a single-layer housing and a multilayer housing. The single-layer housing is easy to process and cheap. However, if an incident angle of an electromagnetic wave is a predetermined degree or more, a transmission loss is increased. Therefore, the single-layer housing is not suitable for mobile satellite broadcasting communicating antenna.

Further, the single-layer housing has a disadvantage in that radio waves with various bands cannot transmit or a transmission loss is high. That is, since the single-layer housing is formed of a material having a constant dielectric permittivity or dielectric constant, it necessarily has a transmission loss of radio waves to a certain extent and thus enables only radio waves with a certain band to transmit. In order to enable radio waves with another band to transmit, a housing formed of a material having a dielectric permittivity that can reduce a transmission loss of radio waves with the corresponding band should be used.

A radio wave incident to a single-layer housing in the air generates a reflective wave due to a difference in dielectric permittivity. The radio wave propagates by 0.5λ with respect to a radio wavelength (λ) and is reflected as a reflective wave so as to return to its original incident position. A phase of the reflective wave is delayed by 360 degrees from the incident position. Therefore, the reflective wave generated at the incident position and the reflective wave generated at the reflection position relatively have a phase difference of 180 degrees, and, thus, they are cancelled by phase inversion. Therefore, the single-layer housing needs to have a thickness maintained at 0.5λ with respect to the used radio wavelength or needs to be manufactured to be very thin. Due to its characteristics, the single-layer housing can be mainly used for a single band or a narrow band only.

However, if a mobile object mounting a satellite antenna thereon is a ship, the satellite antenna receives or transmits (i.e. communicates) radio waves with various bands or a broad band. Thus, a housing installed at the satellite antenna also needs to enable the radio waves with various bands or a broad band. Further, the housing has been increasingly demanded to maintain a mechanical strength.

Furthermore, even if electromagnetic waves such as radio waves transmit a satellite antenna housing at the same angle, transmission losses and performances of the electromagnetic waves are different depending on a form or a shape, a radius of curvature of the housing.

### DISCLOSURE

### Technical Problem

The present invention is suggested to solve the above-described problems, and provides a satellite antenna housing that enables radio waves with various bands or a broad band to transmit.

The present invention provides a satellite antenna housing that can prevent a decrease in mechanical strength while reducing a transmission loss of radio waves.

The present invention provides a satellite antenna housing that enables radio waves with a broad band to transmit while a form or a shape of the housing is maintained.

The present invention provides a satellite antenna housing that can achieve a constant performance without a great transmission loss of electromagnetic waves regardless of a form or a shape, a radius of curvature of the housing even if the electromagnetic waves transmit the satellite antenna housing at the same angle.

### Technical Solution

In order to achieve the above-described objects, an exemplary embodiment of the present invention provides a satellite antenna housing including: a first layer; a second layer formed so as to be in contact with one side of the first layer; a third layer formed so as to be in contact with one side of the second layer and face the first layer; a fourth layer so as to be in contact with one side of the third layer and face the second layer; and a fifth layer so as to be in contact with one side of the fourth layer and face the third layer, wherein the first layer, the third layer, and the fifth layer may be formed of a material having a higher dielectric constant than a dielectric constant of a material of the second layer and the fourth layer, and the second layer and the fourth layer may have a greater thickness than that of the first layer, the third layer, and the fifth layer.

The housing having a multilayer structure as described above can receive or transmit (i.e. communicate) satellite radio signals with various bands and can also increase the strength of the housing while minimizing a transmission loss of radio waves depending on each band.

Further, according to the present invention, a satellite antenna housing in which a satellite antenna is mounted includes: an upper housing that accommodates a reflecting plate (or reflector) of the satellite antenna; and a lower housing on which a pedestal of the satellite antenna is mounted and which is connected to the upper housing, wherein the upper housing includes a first housing formed into a semi-spherical shape and a second housing connected or integrated with the first housing and formed into a cylindrical shape, and transmission losses of electromagnetic waves transmitting the first housing and the second housing at the same incident angle are the same between the first housing and the second housing.

A height of the first housing may be smaller than a height of the second housing.

A ratio of the height of the second housing to the height of the first housing may be more than 1 to less than 1.3.

The height of the second housing may be smaller than a diameter of the second housing.

A ratio of the diameter of the second housing to the height of the second housing may be more than 1.4 to less than 1.8.

A safety gap may be formed between an edge of the reflecting plate (or reflector) in a radial direction and an inner surface of the first housing, and the safety gap may be formed so as not to exceed 100 mm.

When an elevation angle of the reflecting plate is a minimum, a shaded area where the reflecting plate and the lower housing are overlapped with each other may be formed to be a minimum.

The upper housing includes: a first layer; a second layer formed so as to be in contact with one side of the first layer; a third layer formed so as to be in contact with one side of the second layer and face the first layer; a fourth layer so as to be in contact with one side of the third layer and face the second layer; and a fifth layer so as to be in contact with one side of the fourth layer and face the third layer, wherein the first layer, the third layer, and the fifth layer may be formed of a material having a higher dielectric constant than a dielectric constant of a material of the second layer and the fourth layer, and the second layer and the fourth layer may have a greater thickness than a thickness of the first layer, the third layer, and the fifth layer.

The first layer, the third layer, and the fifth layer have the same first dielectric constant and the second layer and the fourth layer have the same second dielectric constant, and the first dielectric constant may be greater than the second dielectric constant.

A ratio of the second dielectric constant to the first dielectric constant may be from 0.2 to 0.3.

The thickness of the third layer may be greater than the thickness of the first layer or the fifth layer.

The first layer and the fifth layer may be formed to have the same thickness.

A ratio of the thickness of the first layer or the fifth layer to the thickness of the third layer may be from 0.45 to 0.55.

The second layer and the fourth layer may be formed to have the same thickness, and a ratio of the thickness of the second layer or the fourth layer to the thickness of the third layer may be from 1.5 to 5.5.

At least one of the first layer, the third layer, or the fifth layer may include fiber glass.

The second layer or the fourth layer may include non-woven fabric and resin.

The resin may include any one selected from the group consisting of polyester, vinyl ester, epoxy resin, acryl resin, acrylonitrile resin, aniline resin, alkylamino resin, isooctane, AS resin (acrylonitrile styrene resin), ethylcellulose, nylon, ebonite, ethylene chloride, and styrol resin.

### Advantageous Effects

As described above, the satellite antenna housing according to an exemplary embodiment of the present invention enables radio waves with various bands or a broad band to transmit while reducing a transmission loss.

The satellite antenna housing according to an exemplary embodiment of the present invention can prevent a decrease in mechanical strength while reducing a transmission loss of radio waves.

Even if the satellite antenna housing according to an exemplary embodiment of the present invention is loaded on a mobile object passing through radio wave bands different from each other, when the radio wave bands are shifted between them, the satellite antenna housing does not need to be replaced.

Even if electromagnetic waves such as radio waves transmit the satellite antenna housing according to an exemplary embodiment of the present invention at the same angle, there is no change in transmission loss of the electromagnetic waves depending on a form or a shape, a radius of curvature of the housing and it is possible to achieve a constant performance.

### DESCRIPTION OF DRAWINGS

FIG. 1 is a perspective view illustrating a satellite antenna housing according to an exemplary embodiment of the present invention;

FIG. 2 to FIG. 4 respectively provide a perspective view, a bottom view, and a longitudinal cross-sectional view illustrating an upper housing of the satellite antenna housing according to the exemplary embodiment of the present invention;

FIG. 5 is a diagram illustrating a positional relationship between a satellite antenna installed within the satellite antenna housing according to the exemplary embodiment of the present invention and the housing;

FIG. 6 is a cross-sectional perspective illustrating a cross-sectional structure of the satellite antenna housing according to the exemplary embodiment of the present invention;

FIG. 7A and FIG. 7B are cross-sectional views each illustrating a stacked structure of the satellite antenna housing according to the exemplary embodiment of the present invention;

FIG. 8 provides simulation data illustrating a transmission loss depending on a radio wave band of the satellite antenna housing according to the exemplary embodiment of the present invention;

FIG. 9 to FIG. 11 provide experimental data illustrating a transmission loss depending on a radio wave band of the satellite antenna housing according to the exemplary embodiment of the present invention;

FIG. 12 provides experimental data illustrating a transmission loss depending on a change in thickness of a first layer, a third layer, or a fifth layer of the satellite antenna housing according to the exemplary embodiment of the present invention; and

FIG. 13 provides experimental data illustrating a transmission loss depending on a change in thickness of a second layer or a fourth layer of the satellite antenna housing according to the exemplary embodiment of the present invention.

### BEST MODE

Hereinafter, exemplary embodiments of the present invention will be explained in detail with reference to the accompanying drawings. However, the present invention is not limited or restricted the following exemplary embodiments. The same reference numerals suggested in each drawing denote the same elements.

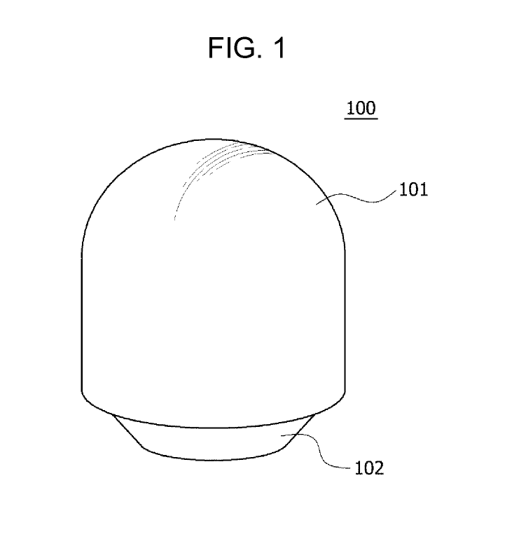

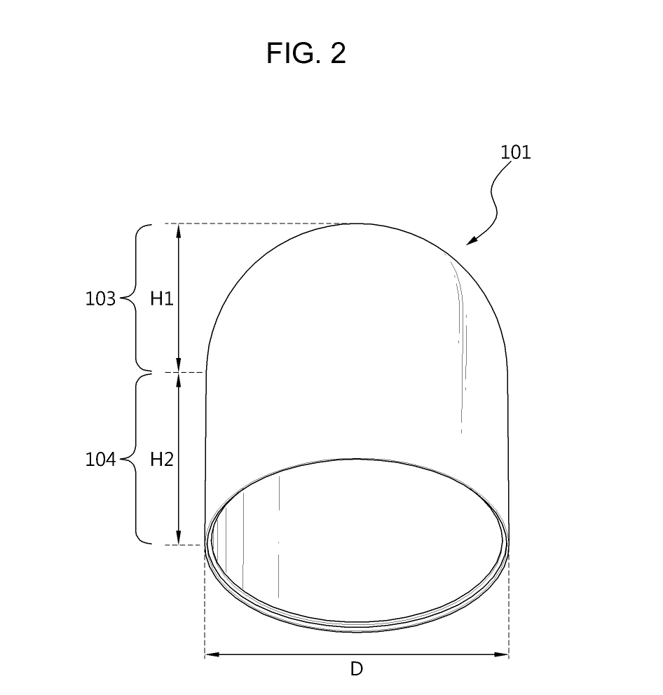

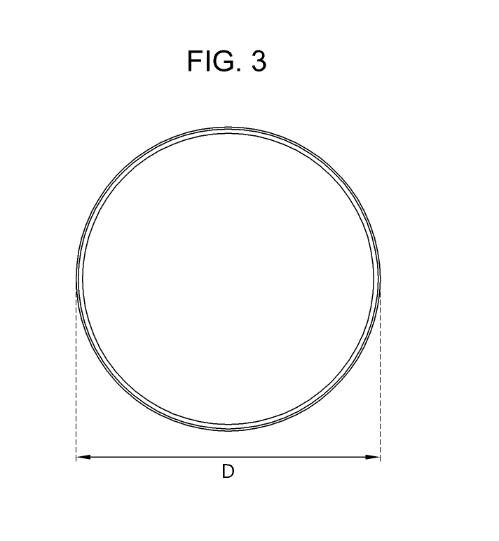

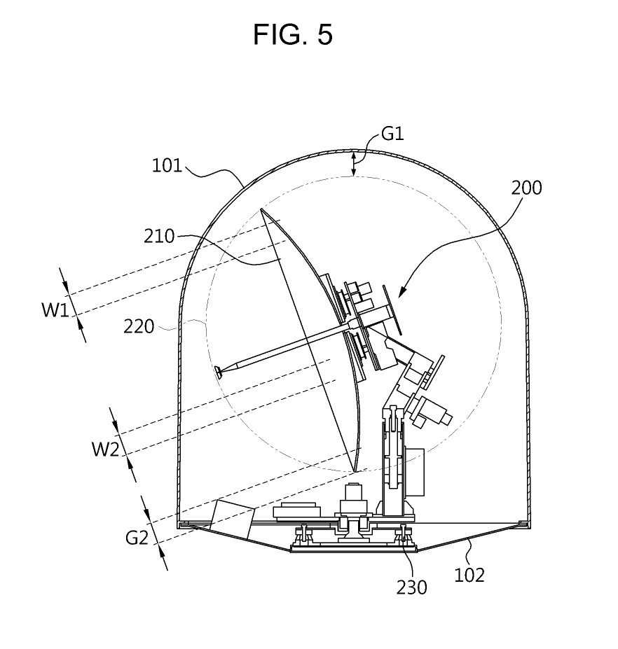

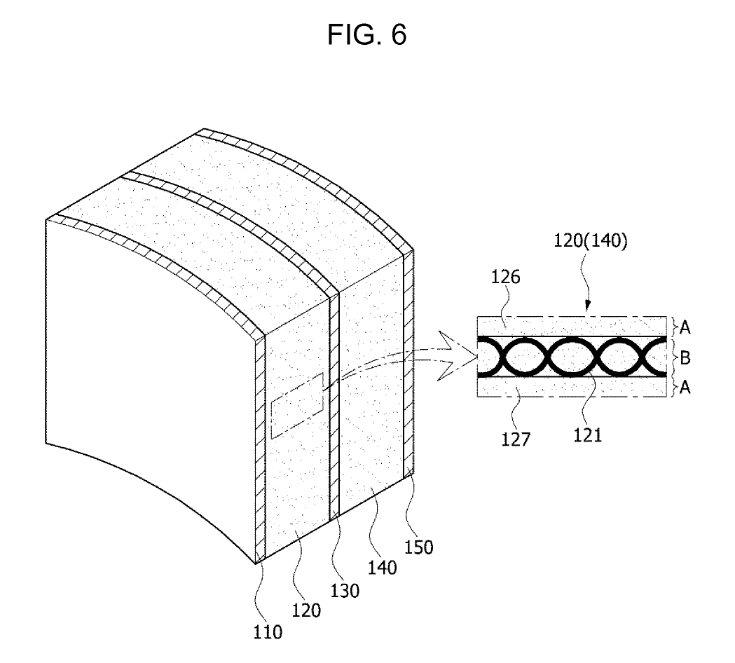

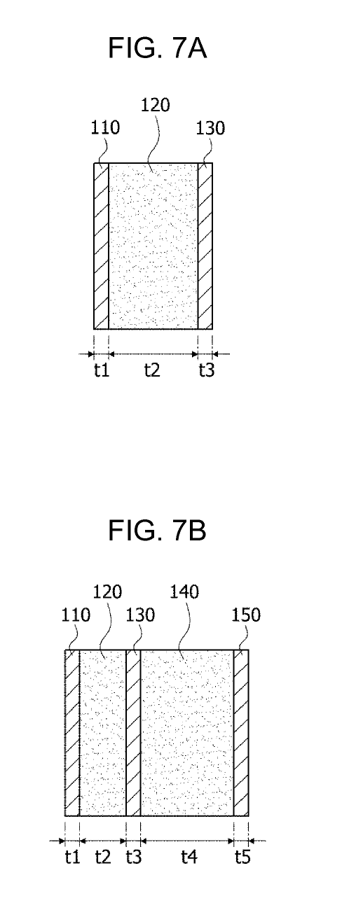

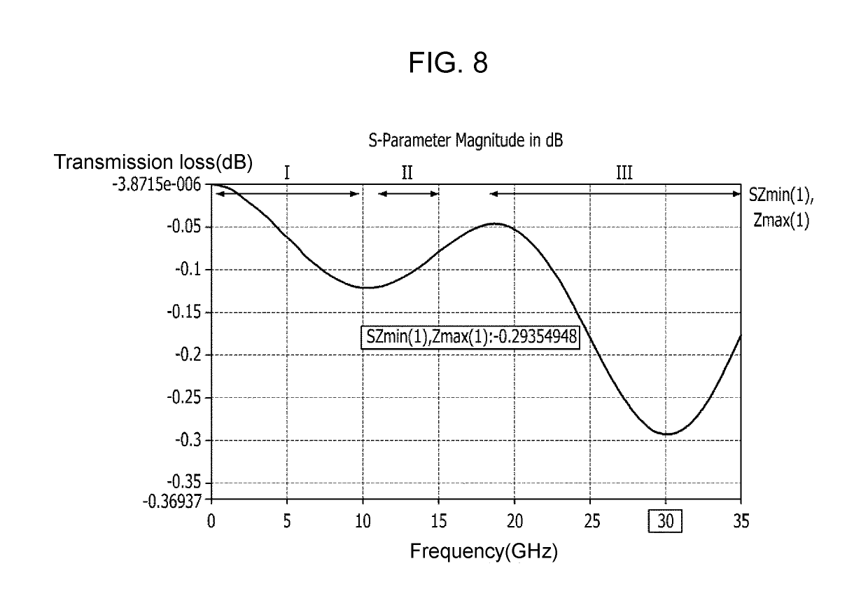

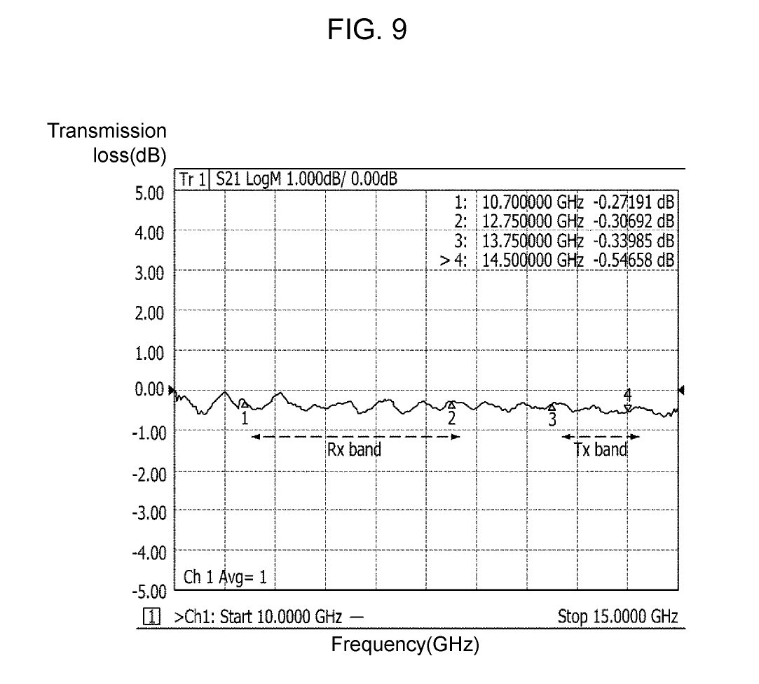

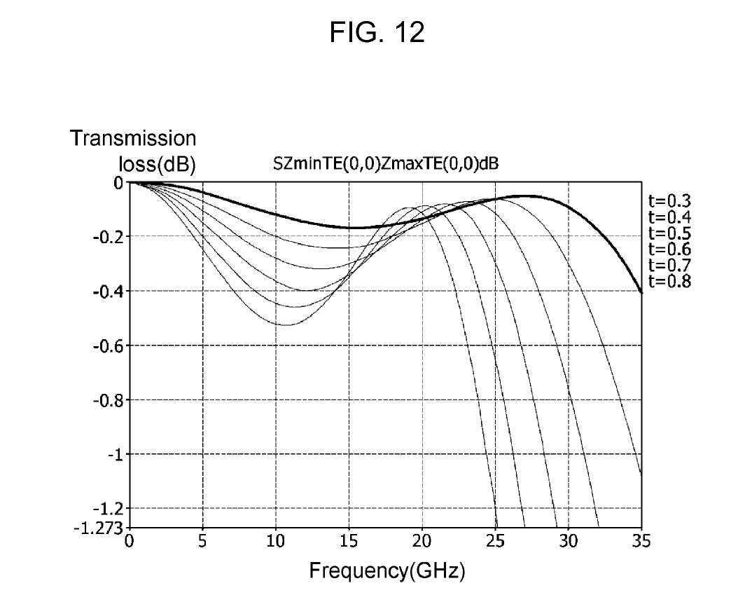

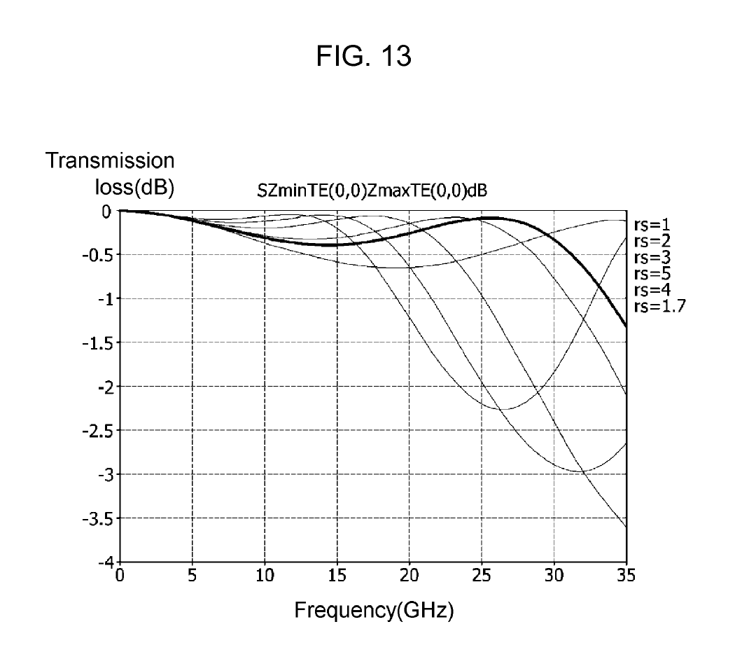

FIG. 1 is a perspective view illustrating a satellite antenna housing according to an exemplary embodiment of the present invention; FIG. 2 to FIG. 4 respectively provide a perspective view, a bottom view, and a longitudinal cross-sectional view illustrating an upper housing of the satellite antenna housing according to the exemplary embodiment of the present invention; FIG. 5 is a diagram illustrating a positional relationship between a satellite antenna installed within the satellite antenna housing according to the exemplary embodiment of the present invention and the housing; FIG. 6 is a cross-sectional perspective illustrating a cross-sectional structure of the satellite antenna housing according to the exemplary embodiment of the present invention; FIG. 7a and FIG. 7b are cross-sectional views each illustrating a stacked structure of the satellite antenna housing according to the exemplary embodiment of the present invention; FIG. 8 provides simulation data illustrating a transmission loss depending on a radio wave band of the satellite antenna housing according to the exemplary embodiment of the present invention; FIG. 9 to FIG. 11 provide experimental data illustrating a transmission loss depending on a radio wave band of the satellite antenna housing according to the exemplary embodiment of the present invention; FIG. 12 provides experimental data illustrating a transmission loss depending on a change in thickness of a first layer, a third layer, or a fifth layer of the satellite antenna housing according to the exemplary embodiment of the present invention; and FIG. 13 provides experimental data illustrating a transmission loss depending on a change in thickness of a second layer or a fourth layer of the satellite antenna housing according to the exemplary embodiment of the present invention.

Above all, a satellite antenna housing according to an exemplary embodiment of the present invention has a concept including a typical radome.

Referring to FIG. 1 to FIG. 5, a satellite antenna housing 100 according to an exemplary embodiment of the present invention in which a satellite antenna 200 is mounted may include an upper housing 101 that accommodates a reflecting plate 210 of the satellite antenna 200 and a lower housing 102 on which a pedestal 230 of the satellite antenna 200 is mounted and which is connected to the upper housing 101. The satellite antenna housing 100 accommodates the satellite antenna 200 in a space where the upper housing 101 and the lower housing 102 are clamped to each other and thus can protect the satellite antenna 200. Preferably, the lower housing 102 is formed into an approximately dish shape, whereas the upper housing 101 may be formed to have a sufficient length to accommodate the satellite antenna 200.

Herein, the upper housing 101 may include a first housing 103 formed into a semi-spherical shape and a second housing 104 connected or integrated with the first housing 103 and formed into a cylindrical shape.

The upper housing 101 of the satellite antenna housing 100 according to the exemplary embodiment of the present invention may be formed by combining or connecting the first housing 103 and the second housing 104 after being manufactured separately for the sake of convenience in manufacturing. For example, after the first housing 103 is manufactured using a semi-spherical mold and the second housing 104 is manufactured using a cylindrical mold, the first housing 103 and the second housing 104 are connected to each other, and finally, the upper housing 101 can be obtained. Since the molds are additionally prepared, production cost may increase, and since a process of connecting the first housing 103 and the second housing 104 is needed, productivity may decrease.

Otherwise, the upper housing 101 may be manufactured using a single mold having the same form as the upper housing 101. In this case, the first housing 103 and the second housing 104 are integrated with each other. As illustrated in FIG. 2, the mold and the upper housing 101 can be separated from each other through an opened lower end portion, and, thus, it is not necessary to use two molds. Therefore, production cost can be reduced, and the process of connecting the first housing 103 and the second housing 104 is not needed, and, thus, productivity can be increased.

Meanwhile, the upper housing 101 of the satellite antenna housing 100 according to the exemplary embodiment of the present invention may be formed such that transmission losses of electromagnetic waves transmitting the first housing 103 and the second housing 104 at the same incident angle are the same between the first housing 103 and the second housing 104. That is, although the satellite antenna housing 100 according to the exemplary embodiment of the present invention are different in form, the satellite antenna housing 100 has an advantage that electromagnetic waves transmitting the first housing 103 and the second housing 104 at the same incident angle have the same transmission loss or almost no difference in transmission loss.

In the case of a conventional radome, the radome must have a shape almost similar to a spherical shape in order to solve a problem that there is a difference in transmission loss caused by directionality of the radome. Further, in order to manufacture the nearly spherical radome, it is necessary to use two spherical molds. Therefore, the conventional radome has a disadvantage that production cost increases, and a process of connecting semi-spherical radomes to each other is needed, and, thus, productivity decreases.

However, the satellite antenna housing 100 according to the exemplary embodiment of the present invention has an advantage that there is little difference in transmission loss of electromagnetic waves caused by a shape or directionality of a housing even if the housings are different in form. Referring to FIG. 5, radio waves W1 and W2 transmitted from a satellite transmit the upper housing 101 at the same incident angle with respect to a horizontal line. In this case, the radio wave W1 passing through the semi-spherical first housing 103 and the radio wave W2 passing through the cylindrical second housing 104 have different lengths of transmission when they transit the upper housing 101. A length of transmission of the radio wave W1 passing through the first housing 103 is longer than a length of transmission of the radio wave W2 passing through the second housing 104. However, there is no significant difference in transmission loss between the radios waves W1 and W2, and it is possible to obtain approximately the same performance. Therefore, in the satellite antenna housing 100 according to the exemplary embodiment of the present invention, it is not necessary to form the upper housing 101 into an almost complete spherical shape and it is not necessary to use several molds.

Since the satellite antenna housing 100 is configured as described above, it is possible to obtain an almost uniform transmission loss of electromagnetic waves regardless of a shape or a part of the satellite antenna housing 100, and also possible to achieve a constant performance regardless of a location of the satellite antenna housing.

The reason why there is no difference in transmission loss although the first housing 103 and the second housing 104 do not have the same form is that the first and second housings 103 and 104 have unique cross-sectional structures, which will be described later.

Referring to FIG. 2 to FIG. 4, a height H1 of the first housing 103 is equivalent to a half diameter D of the first housing 103, and a diameter of the second housing 104 is equivalent to the diameter of the first housing 103.

The height H1 of the first housing 103 may be smaller than a height H2 of the second housing 104. The reason why the height H2 of the second housing 104 is longer than the height H1 of the first housing 103 is that within the first housing, the reflecting plate 210 of the satellite antenna 200 is mainly positioned but within the second housing 104, a device unit (not illustrated) supporting the reflecting plate 210 is positioned. That is, such a device unit has a sufficient length, and, thus, preferably, the second housing 104 accommodating the device unit may also have a sufficient length. Herein, a ratio of the height H2 of the second housing 104 to the height H1 of the first housing 103 may be more than 1 to less than 1.3.

Further, the height H2 of the second housing 104 may be smaller than a diameter D of the second housing 104. Herein, the height H2 of the second housing 104 has such a value that the total height H1+H2 of the first housing 103 and the second housing 104 is equal to or greater than the diameter D of the first or second housing 103 or 104. This is because if the total height H1+H2 of the first housing 103 and the second housing 104 is smaller than the diameter D of the first or second housing 103 or 104, the reflecting plate 210 cannot freely move within the upper housing 101. Herein, a ratio of the diameter D of the second housing 104 to the height H2 of the second housing 104 may be more than 1.4 to less than 1.8.

Meanwhile, as illustrated in FIG. 5, preferably, a safety gap G1 may be formed between an edge of the reflecting plate 210 in a radial direction and an inner surface of the first housing 103 and the safety gap G1 may be formed so as not to exceed about 100 mm, but is not necessarily limited thereto. Within the upper housing 101, the edge of the reflecting plate 210 of the satellite antenna 200 can move along a spherical path 220. If the safety gap G1 is not present between the reflecting plate 210 and the first housing 103, the reflecting plate 210 and the first housing 103 may collide with each other due to a movement of a mobile object on which the satellite antenna 200 is mounted.

When an elevation angle of the reflecting plate 210 is a minimum, a shaded area G2 where the reflecting plate 210 and the lower housing 102 are overlapped may be formed.

As illustrated in FIG. 5, when the reflecting plate 210 is tilted toward the lowermost side, a part of a lower end edge of the reflecting plate 210 is not overlapped with the upper housing 101 but overlapped with the lower housing 102. That is, with respect to a linear path of incident radio waves, the radio waves incident toward a lower end side of the reflecting plate 210 do not pass through the upper housing 101 but passes through the lower housing 103. Therefore, the radio waves passing through the lower housing 103 and incident to the reflecting plate 210 cannot be treated by the satellite antenna 200, and, thus, a part (or an area) where the reflecting plate 210 and the lower housing 103 are overlapped with each other is referred to as “shaded area G2”.

Herein, when an elevation angle of the reflecting plate 210 is a minimum (i.e. the reflecting plate 210 has a low elevation angle), a size of the shaded area G2 or a width of the shaded area G2 in a radial direction of the reflecting plate 210 may be a minimum. The satellite antenna housing 100 according to the exemplary embodiment of the present invention has an advantage that the second housing 104 has a cylindrical shape, and, thus, the shaded area G2 can be reduced as compared with a case where the second housing has a circular cone shape.

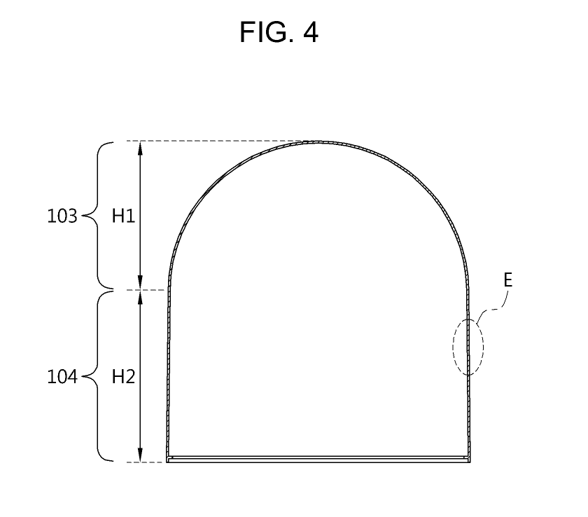

Hereinafter, referring to the accompanying drawings, a cross-sectional structure of the satellite antenna housing 100 according to the exemplary embodiment of the present invention will be explained. FIG. 6 is a diagram illustrating an enlarged cross-sectional structure of the upper housing 102 in a section “E” of FIG. 4.

The satellite antenna housing 100 according to the exemplary embodiment of the present invention is a multilayer housing in which multiple layers are stacked, as illustrated in FIG. 6, FIG. 7a, and FIG. 7b. A housing in which three layers are stacked is referred to as “A type sandwich housing” and a housing in which five layers are stacked is referred to as “C type sandwich housing”. In FIG. 7a, three layers are stacked, and a housing having such a structure is referred to as “A type sandwich housing”. In FIG. 7b, five layers are stacked, and a housing having such a structure is referred to as “C type sandwich housing”.

The satellite antenna housing 100 according to the exemplary embodiment of the present invention has a structure in which a layer having a high dielectric permittivity or dielectric constant and a layer having a low dielectric permittivity or dielectric constant are stacked alternately or repeatedly.

As illustrated in FIG. 7a, the satellite antenna housing 100 according to the exemplary embodiment of the present invention may be formed to have an A type sandwich structure in which three layers are stacked. That is, the satellite antenna housing 100 may be formed by stacking the first to third layers 110, 120, and 130 to be bonded to each other or to be in contact with each other.

Herein, the first layer 110 and the third layer 130 are formed of the same material, but the second layer 120 is formed of a material different from that of the first/third layer 110 or 130. The first and third layers 110 and 130 are formed of a material having a high dielectric permittivity or dielectric constant as compared with the second layer 120, and the second layer 120 is formed of a material having a lower dielectric permittivity or dielectric constant.

Since the first and third layers 110 and 130 form a surface of the housing 100, they need to have a sufficient mechanical strength to protect the satellite antenna from physical impacts or the like. Herein, the first and third layers 110 and 130 have the purpose of increasing a mechanical strength, and, thus, they have a high dielectric permittivity, consequently resulting in a great transmission loss of radio waves. Therefore, preferably, thicknesses t1 and t3 of the first and third layers 110 and 130, respectively, may be smaller than a thickness t2 of the second layer 120. Preferably, a ratio of the thicknesses t1 and t3 of the first and third layers 110 and 130 to the thickness t2 of the second layer 120 may be from 0.1 to 0.3.

Meanwhile, when a wavelength of a radio wave transmitting the second layer 120 is “λ,”, the thickness t2 of the second layer 120 may have a value of 0.25λ.

On the other hand, in order to minimize the overall transmission loss of radio waves in the housing 100, preferably, the second layer 120 may have a low dielectric permittivity or dielectric constant. Preferably, a ratio of the dielectric permittivity or dielectric constant of the second layer 120 to the dielectric permittivity or dielectric constant of the first and third layers 110 and 130 may be from 0.2 to 0.3.

The first and third layers 110 and 130 may be formed of any one of fiber glass, reinforced fiber glass, or reinforced fiber.

Further, the second layer 120 may be formed of non-woven fabric and resin. That is, the second layer 120 may be formed by immersing resin in non-woven fabric. In this case, the non-woven fabric may be formed of cotton, viscose rayon, nylon, and the like, and the resin may be formed of any one selected from the group consisting of polyester, vinyl ester, epoxy resin, acryl resin, acrylonitrile resin, aniline resin, alkylamino resin, isooctane, AS resin (acrylonitrile styrene resin), ethylcellulose, nylon, ebonite, ethylene chloride, and styrol resin.

Further, the second layer 120 may be formed of at least one of a gel coat, a yarn cloth, or a core mat. Herein, the core mat may be formed of non-woven fabric or the like.

Meanwhile, as illustrated in FIG. 7b, the satellite antenna housing 100 according to the exemplary embodiment of the present invention may be formed to have a C type sandwich structure in which five layers are stacked. That is, the satellite antenna housing 100 may be formed by stacking first to fifth layers 110, 120, 130, 140, and 150 to be bonded to each other or to be in contact with each other.

The satellite antenna housing 100 according to the exemplary embodiment of the present invention as illustrated in FIG. 7b may include: the first layer 110; the second layer 120 formed so as to be in contact with one side of the first layer 110; the third layer 130 formed so as to be in contact with one side of the second layer 120 and face the first layer 110; a fourth layer 140 so as to be in contact with one side of the third layer 130 and face the second layer 120; and a fifth layer 150 so as to be in contact with one side of the fourth layer 140 and face the third layer 130.

That is, in the satellite antenna housing 100 according to the exemplary embodiment of the present invention with the C type sandwich structure, five layers are stacked in sequence. Herein, preferably, the first layer 110, the third layer 130, and the fifth layer 150 may be formed of a material having a higher dielectric permittivity or dielectric constant than a dielectric constant of a material of the second layer 120 and the fourth layer 140. The first layer 110, the third layer 130, and the fifth layer 150 are formed of a material which conducts electricity relatively well and through which electromagnetic waves do not pass well, and the second layer 120 and the fourth layer 140 are formed of a material which does not conduct electricity relatively well but through which electromagnetic waves passes well.

Similar to the above-described A type sandwich structure as illustrated in FIG. 7a, the first layer 110, the third layer 130, and the fifth layer 150 are layers for maintaining a mechanical strength of the housing, and the second layer 120 and the fourth layer 140 are layers for reducing a transmission loss of radio waves in the housing. Therefore, in order to reduce a transmission loss while maintaining a high mechanical strength, preferably, the thickness t1 of the first layer 110, the thickness t3 of the third layer 130, and a thickness t5 of the fifth layer 150 may be smaller than the thicknesses t2 and t4 of the second and fourth layers 120 and 140, respectively. It is possible to minimize a transmission loss of radio waves by setting the thicknesses t2 and t4 of the second and fourth layers 120 and 140, respectively to be as great as possible.

The housing having the above-described multilayer structure can receive or transmit a satellite radio signal with various bands, and it is possible to increase a mechanical strength of the housing while minimizing a transmission loss of radio waves depending on each band.

The first layer 110, the third layer 130, and the fifth layer 150 of the housing 100 having the C type sandwich structure may be formed to have the same first dielectric constant (or first dielectric permittivity), and the second layer 120 and the fourth layer 140 may be formed to have the same second dielectric constant (or second dielectric permittivity). That is, the first layer 110, the third layer 130, and the fifth layer 150 are formed of the same material, and the second layer 120 and the fourth layer 140 may be formed of the same material which may be different from the material of the first layer 110, the third layer 130, and the fifth layer 150.

Herein, the first dielectric constant may be higher than the second dielectric constant. The first layer 110, the third layer 130, and the fifth layer 150 may be formed of a material which conducts electricity relatively well and through which electromagnetic waves do not pass well, and the second layer 120 and the fourth layer 140 may be formed of a material which does not conduct electricity relatively well but through which electromagnetic waves passes well.

Meanwhile, a ratio of the second dielectric constant to the first dielectric constant may be from 0.2 to 0.3. As such, by setting the dielectric constant of the first layer 110, the third layer 130, and the fifth layer 150 to be about four times greater than the dielectric constant of the second layer 120 and the fourth layer 140, it is possible to reduce the overall transmission loss of radio waves in the satellite antenna housing 100, and even if a housing having the same structure is used with respect to a broad band, a difference in transmission loss depending on a band is not significant.

In the satellite antenna housing 100 according to the exemplary embodiment of the present invention, since a mechanical strength of the housing needs to be maintained while a transmission loss with respect to a broad band is minimized, it is important to set a thickness of each layer.

The thickness t3 of the third layer 130 may be greater than the thickness t1 of the first layer 110 or the thickness t5 of the fifth layer 150. Preferably, the first layer 110, the third layer 130, and the fifth layer 150 in charge of a mechanical strength of the housing 100 do not have the same thickness, but the first and fifth layers 110 and 150 forming the surface of the housing 100 are formed to be thinner than the third layer 130. Unlike the first and fifth layers 110 and 150, the third layer 130 does not form the surface of the housing 100, and, thus, the third layer 130 less contribute to maintenance of the mechanical strength as compared with the first and fifth layers 110 and 150. According to circumstances, the third layer 130 may be formed of a material different from that of the first and fifth layers 110 and 150, i.e. a material having a lower dielectric constant than the dielectric constant of the first and fifth layers 110 and 150.

Meanwhile, the first layer 110 and the fifth layer 150 forming an outer surface and the surface of the housing 100 may be formed to have the same thickness. In this case, a ratio of the thickness t1 or t5 of the first layer 110 or the fifth layer 150, respectively, to the thickness t3 of the third layer 130 may be from 0.45 to 0.55. For example, preferably, the thickness t3 of the third layer 130 may be about two times greater than the thickness t1 of the first layer 110 or the thickness t5 of the fifth layer 150. As such, since the first and fifth layers 110 and 150 are formed to have the minimum thickness, a strength of the surface of the housing 100 can be increased and an increase in transmission loss of radio waves caused by a high-strength layer can be prevented.

As described above, the thickness t1 of the first layer 110, the thickness t3 of the third layer 130, and the thickness t5 of the fifth layer 150 may be smaller than the thicknesses t2 and t4 of the second and fourth layers 120 and 140, respectively.

In this case, the thickness t2 of the second layer 120 may be the same as the thickness t4 of the fourth layer 140, and a ratio of the thickness t2 of the second layer 120 or the thickness t4 of the fourth layer 140 to the thickness t3 of the third layer 130 may be from 4.5 to 5.5. For example, the second layer 120 or the fourth layer 140 may be formed to be about four times thicker than the third layer 130. Otherwise, the second layer 120 or the fourth layer 140 may be formed to be about eight times thicker than the first layer 110 or the fifth layer 150.

Herein, the second layer 120 or the fourth layer 140 is manufactured by immersing non-woven fabric or resin as described later, and preferably, it is manufactured by a vacuum infusion method in order to reduce an amount of resin to be immersed. If the vacuum infusion method is used, a thickness of the non-woven fabric forming the second layer 120 or the fourth layer 140 is reduced. Therefore, a ratio of the thickness t2 of the second layer 120 or the thickness t4 of the fourth layer 140 to the thickness t3 of the third layer 130 may be from about 1.5 to about 5.5.

Meanwhile, when a wavelength of a radio wave transmitting the housing 100 is “λ”, the thicknesses t2 and t4 of the second layer 120 and the fourth layer 140, respectively, may have a value of 0.25λ. According to circumstances, the thicknesses t2 and t4 of the second layer 120 and the fourth layer 140, respectively, may be different from each other, but preferably, the second layer 120 and the fourth layer 140 may have the same thickness.

As such, since the second and fourth layers 120 and 140 having the lowest dielectric constant are formed to be thickest, a transmission loss of radio waves in the housing 100 can be minimized, and a difference in transmission loss with respect to various bands can be insignificant.

At least one of the first layer 110, the third layer 130, or the fifth layer 150 may be formed of any one of fiber glass, reinforced fiber glass, or reinforced fiber. The fiber glass has a dielectric constant of about 4 and has a relatively high mechanical strength.

Meanwhile, the second layer 120 or the fourth layer 140 may be formed of non-woven fabric and resin. As illustrated in FIG. 6, the second layer 120 or the fourth layer 140 is formed by immersing resins 126 and 127 in a non-woven fabric 121, and may include a resin layer A and a non-woven fabric layer B. As described above, the second layer 120 or the fourth layer 140 can be manufactured by the vacuum infusion method. If the vacuum infusion method is used, an amount of the resin to be immersed can be reduced. As an amount of the resin to be immersed decreases, a strength of the second layer 120 or the fourth layer 140 increases and a transmission loss of radio waves decreases.

Further, the second layer 120 or the fourth layer 140 may be formed of at least one of a gel coat, a yarn cloth, or a core mat. Herein, the core mat may be formed of non-woven fabric or the like.

Herein, as a loss tangent value of the resins 126 and 127 decreases, a transmission loss of radio waves may decrease. The resin may include any one selected from the group consisting of polyester, vinyl ester, epoxy resin, acryl resin, acrylonitrile resin, aniline resin, alkylamino resin, isooctane, AS resin (acrylonitrile styrene resin), ethylcellulose, nylon, ebonite, ethylene chloride, and styrol resin.

FIG. 8 provides simulation data for checking a transmission loss of radio waves in each radio wave band with respect to the housing 100 having the C type sandwich structure according to the exemplary embodiment of the present invention.

Referring to FIG. 8, it can be seen that among radio wave bands, in Band L (1.450 to 1.800 GHz), Band S (2.170 to 2.655 GHz), Band C (3.400 to 4.800 GHz), and Band X (6.700 to 7.750 GHz) (Band I), a transmission loss is 0.15 dB or less; in Band Ku (10.700 to 12.750 GHz) (Band II), a transmission loss is 0.15 dB or less; and in Band Ka (17.700 to 21.200 GHz) (Band III), a transmission loss is 0.3 dB or less. That is, it can be seen that there is very little difference in loss between Band I and Band II, and also, a loss in Band III is not much greater than the losses of the other bands. Since the satellite antenna housing 100 according to the exemplary embodiment of the present invention does not have a great transmission loss depending on a frequency band of a radio wave, even if it is mounted on a mobile object such as a ship, it can be used in a broad band.

Meanwhile, FIG. 9 to FIG. 11 provide experimental measurement data for checking a transmission loss in the case of communicating, i.e. receiving (Rx band) and transmitting (Tx band), a radio wave in Band Ku and Band Ka using the housing 100 having the C type sandwich structure as illustrated in FIG. 7b according to the exemplary embodiment of the present invention.

FIG. 9 illustrates an amount of a loss in the receiving band (Rx band) and the transmitting band (Tx band) in Band Ku. An average amount of a loss in the receiving band is about 0.3 dB, and an average amount of a loss in the transmitting band is about 0.5 dB.

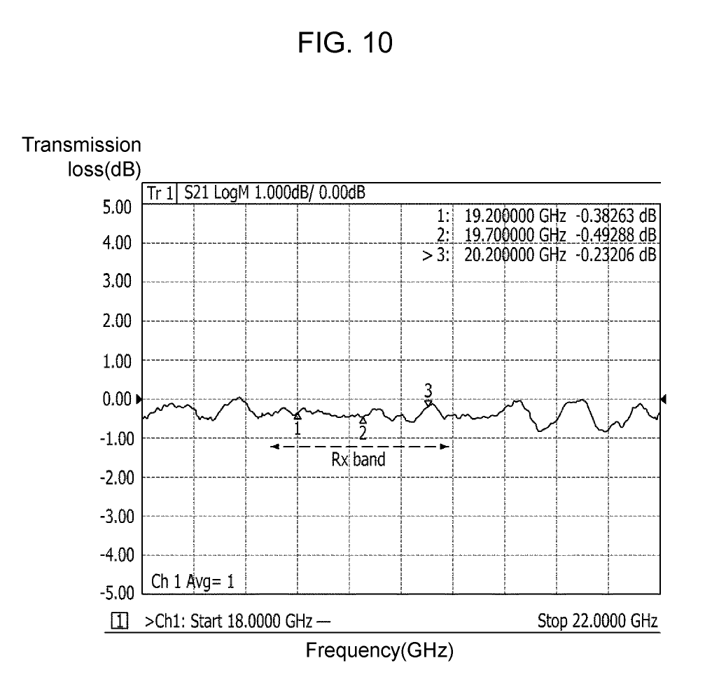

FIG. 10 illustrates an amount of a loss in the receiving band (Rx band) in Band Ka. In this case, an average amount of a loss is about 0.5 dB.

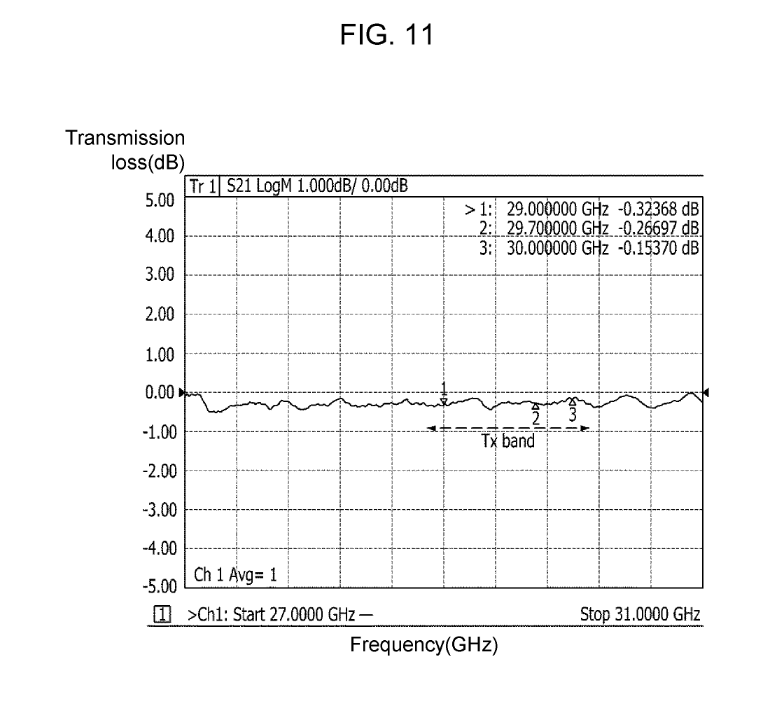

FIG. 11 illustrates an amount of a loss in the transmitting band (Tx band) in Band Ka. In this case, an average amount of a loss is about 0.3 dB.

By comparison among the experimental measurement data in FIG. 9 to FIG. 11, it can be seen that the housing 100 having the C type sandwich structure as illustrated in FIG. 7b according to the exemplary embodiment of the present invention has transmission losses transmitted and received in Band Ku and Band Ka in the range of about 0.3 dB to about 0.5 dB, and, thus, there is no significant difference in transmission loss. Therefore, the housing 100 according to the exemplary embodiment of the present invention has a small transmission loss in Band Ku and Band Ka, and, thus, it can be used in both of Band Ku and Band Ka, and there is no significant difference in transmission loss depending on a band, and, thus, the housing 100 can be used in various bands and in a broad band.

FIG. 12 illustrates graphs each illustrating a change in transmission loss depending on a change in thickness t1, t3, or t5 of the first layer 110, the third layer 130, or the fifth layer 150 of the satellite antenna housing 100 according to the exemplary embodiment of the present invention.

The graphs of FIG. 12 illustrate transmission losses depending on a frequency of a radio wave transmitting the housing 100 when the thickness t1, t3, or t5 of the first layer 110, the third layer 130, or the fifth layer 150 has six values. It can be seen that when the thickness t1, t3, or t5 is 0.3 mm (the graph expressed by a relatively thick solid line in FIG. 12), the overall transmission loss is small with respect to all of the frequency bands. That is, the graphs of FIG. 12 illustrate that the thickness t1, t3, or t5 of the first layer 110, the third layer 130, or the fifth layer 150 decreases, a transmission loss decreases.

FIG. 13 illustrates graphs each illustrating a transmission loss depending on a change in thickness t2 or t4 of the second layer 120 or the fourth layer 140 of the satellite antenna housing 100 according to the exemplary embodiment of the present invention. In the graphs of FIG. 13, ‘rs’ represents the thickness t2 or t4 of the second layer 120 or the fourth layer 140.

The graphs of FIG. 13 illustrate transmission losses depending on a frequency of a radio wave transmitting the housing 100 when the thickness t2 or t4 of the second layer 120 or the fourth layer 140 has six values. It can be seen that when the thickness t2 or t4 is 1.7 mm (the graph expressed by a relatively thick solid line in FIG. 12), the overall transmission loss is small with respect to all of the frequency bands.

According to the graphs of FIG. 12 and FIG. 13, if the thicknesses of the first and fifth layers 110 and 150 of the radio wave transmitting the housing 100 according to the exemplary embodiment of the present invention are 0.25 mm, the thickness of the third layer 130 is 0.5 mm, and the thicknesses of the second layer 120 and the fourth layer 140 are 2 mm. Herein, as described above, in order to reduce an amount of resin to be immersed, the second layer 120 and the fourth layer 140 are manufactured by the vacuum infusion method, and, thus, a final thickness of the second layer 120 or the fourth layer 140 may be less than 2 mm.

As described above, since the satellite antenna housing according to the exemplary embodiment of the present invention is formed by stacking multiple layers, it is possible to prevent a decrease in mechanical strength and also possible to continuously use the same housing in a broad band. Further, it is possible to reduce a difference in transmission loss caused by a form of the upper housing and also possible to achieve a constant performance of the satellite antenna.

As described above, although the exemplary embodiments of the present invention have been described in connection with specific matters, such as detailed elements, and the limited exemplary embodiments and drawings, they are provided only to help general understanding of the present invention, and the present invention is not limited to the exemplary embodiments. A person having ordinary skill in the art to which the present invention pertains may modify and change the present invention in various ways from the above description. Accordingly, the spirit of the present invention should not be construed as being limited to the exemplary embodiments, and not only the claims to be described later, but also all equal or equivalent modifications thereof should be constructed as belonging to the category of a spirit of the present invention.

### INDUSTRIAL APPLICABILITY

The present invention can be used for a satellite antenna mounted on a mobile object such as a vehicle, and a ship.

1. A satellite antenna housing comprising:
a first layer;
a second layer formed so as to be in contact with one side of the first layer;
a third layer formed so as to be in contact with one side of the second layer and face the first layer;
a fourth layer so as to be in contact with one side of the third layer and face the second layer; and
a fifth layer so as to be in contact with one side of the fourth layer and face the third layer,
wherein the first layer, the third layer, and the fifth layer are formed of a material having a higher dielectric constant than a dielectric constant of a material of the second layer and the fourth layer, and
the second layer and the fourth layer have a greater thickness than that of the first layer, the third layer, and the fifth layer.

2. A satellite antenna housing in which a satellite antenna is mounted comprises:
an upper housing that accommodates a reflecting plate of the satellite antenna; and
a lower housing on which a pedestal of the satellite antenna is mounted and which is connected to the upper housing,
wherein the upper housing includes a first housing formed into a semi-spherical shape and a second housing connected or integrated with the first housing and formed into a cylindrical shape, and
transmission losses of electromagnetic waves transmitting the first housing and the second housing at the same incident angle are the same between the first housing and the second housing.

3. The satellite antenna housing of claim 2, wherein a height of the first housing is smaller than a height of the second housing.

4. The satellite antenna housing of claim 3, wherein a ratio of the height of the second housing to the height of the first housing is more than 1 to less than 1.3.

5. The satellite antenna housing of claim 3, wherein the height of the second housing is smaller than a diameter of the second housing.

6. The satellite antenna housing of claim 5, wherein a ratio of the diameter of the second housing to the height of the second housing is more than 1.4 to less than 1.8.

7. The satellite antenna housing of claim 5, wherein a safety gap is formed between an edge of the reflecting plate in a radial direction and an inner surface of the first housing, and the safety gap is formed so as not to exceed 100 mm.

8. The satellite antenna housing of claim 7, wherein when an elevation angle of the reflecting plate is a minimum, a shaded area where the reflecting plate and the lower housing are overlapped with each other may be formed to be a minimum.

9. The satellite antenna housing of claim 2, wherein the upper housing includes:
a first layer;
a second layer formed so as to be in contact with one side of the first layer;
a third layer formed so as to be in contact with one side of the second layer and face the first layer;
a fourth layer so as to be in contact with one side of the third layer and face the second layer; and
a fifth layer so as to be in contact with one side of the fourth layer and face the third layer,
wherein the first layer, the third layer, and the fifth layer are formed of a material having a higher dielectric constant than a dielectric constant of a material of the second layer and the fourth layer, and
the second layer and the fourth layer have a greater thickness than a thickness of the first layer, the third layer, and the fifth layer.

10. The satellite antenna housing of claim 1 or claim 9, wherein the first layer, the third layer, and the fifth layer have the same first dielectric constant and the second layer and the fourth layer have the same second dielectric constant, and
the first dielectric constant is greater than the second dielectric constant.

11. The satellite antenna housing of claim 10, wherein a ratio of the second dielectric constant to the first dielectric constant is from 0.2 to 0.3.

12. The satellite antenna housing of claim 10, wherein the thickness of the third layer is greater than the thickness of the first layer or the fifth layer.

13. The satellite antenna housing of claim 12, wherein the first layer and the fifth layer are formed to have the same thickness.

14. The satellite antenna housing of claim 13, wherein a ratio of the thickness of the first layer or the fifth layer to the thickness of the third layer is from 0.45 to 0.55.

15. The satellite antenna housing of claim 14, wherein the second layer and the fourth layer are formed to have the same thickness, and a ratio of the thickness of the second layer or the fourth layer to the thickness of the third layer is from 1.5 to 5.5.

16. The satellite antenna housing of claim 10, wherein at least one of the first layer, the third layer, or the fifth layer includes fiber glass.

17. The satellite antenna housing of claim 16, wherein the second layer or the fourth layer includes non-woven fabric and resin.

18. The satellite antenna housing of claim 17, wherein the resin includes any one selected from the group consisting of polyester, vinyl ester, epoxy resin, acryl resin, acrylonitrile resin, aniline resin, alkylamino resin, isooctane, AS resin (acrylonitrile styrene resin), ethylcellulose, nylon, ebonite, ethylene chloride, and styrol resin.
